(19) United States
(12) Patent Application Publication
(10) Pub. No.: US 2017/0048854 A1
(43) Pub. Date: Feb. 16, 2017

(54) Methods and Devices for Scheduling Subscription Tasks in Multi-Subscription Devices

(71) Applicant: QUALCOMM Incorporated, San Diego, CA (US)

(72) Inventors: Raghavendra Shyam Anand, Chickballapur (IN); Parthasarathy Krishnamoorthy, San Diego, CA (US); Anand Rajurkar, Hyderabad (IN)

(21) Appl. No.: 14/821,889

(22) Filed: Aug. 10, 2015

(51) Int. Cl. H04W 72/04; H04W 24/02

(52) U.S. Cl. CPC H04W 72/0453; H04W 24/02

(57) ABSTRACT

Methods and devices are disclosed for enabling improved scheduling of non-time bounded tasks across multiple subscriptions of a multi-subscription wireless communication device. A processor of the wireless communication device may determine whether the frequency utilized by a radio access technology (RAT) of a first subscription interferes with one or more frequencies utilized by RATs of other subscriptions. In response to determining that two or more of the subscriptions are non-interfering (i.e., RAT frequencies do not interfere) the processor may co-mingle non-time bounded tasks with time bounded tasks of the same subscription to produce consolidated task blocks. The task blocks may be temporal chunks of an execution queue in which tasks are scheduled continuously without interim idle periods. The processor may execute the first task block of each execution queue concurrently across subscriptions to reduce the amount of time that only a portion of the subscriptions are active or dormant.

### BACKGROUND

Wireless communication networks are widely deployed to provide various communication services such as voice, packet data, broadcast, messaging, and so on. Such wireless networks may be capable of supporting communication for multiple users by sharing the available network resources. Examples of such wireless networks include Global System for Mobile Communications (GSM), Code Division Multiple Access (CDMA) networks, Time Division Multiple Access (TDMA) networks, and Frequency Division Multiple Access (FDMA) networks. These wireless networks may also utilize various radio technologies such as Wideband-CDMA (WCDMA), cdma2000, Global System for Mobile Communications (GSM), etc.

Wireless communication devices that include two or more subscriptions may connect to two or more separate mobile telephony networks (e.g., GSM, TDSCDMA, CDMA2000, and WCDMA) using two or more separate radio frequency (RF) resources. Such wireless communication devices are termed multi-subscription-multi-active (MSMA) communication devices. For example, a first subscription might be configured to connect to both WCDMA and GSM networks, while a second subscription might be capable of connecting to GSM networks. A MSMA (e.g., a DSDA/TSTA Multi-Subscription Device) may have multiple receivers and PLL's, capable of supporting frequency aggregation as well as concurrent activities across the radio technologies, at the same time.

Another type of multi-subscription wireless communication device includes a single RF resource that is shared among two or more subscriptions for connecting to two or more networks. Because the single RF resource is shared such that only one subscription can transmit at a time, such devices are referred to as multi-subscription multi-standby (MSMS) devices. Some MSMS devices also include multiple receiver circuits (i.e., one transmitter but multiple receivers) in order to support carrier aggregation techniques.

Different radio access technologies (RATs) of subscriptions to different types of networks include time-bounded (e.g., page read) and non-time bounded (e.g., neighbor reads, overhead collection etc.) network communication activities, each of which may consume an associated amount of battery power. In conventional MSMA communication devices, each receiving subscription performs both power monitoring and paging reception during its idle-mode operations. Independently scheduling subscription downlink activities for each subscription or RAT according to each network's timelines can increase the amount of time that receiver circuits are energized, and thus result in unnecessary power consumption

### SUMMARY

The methods and apparatuses of various embodiments provide circuits and methods for managing execution of non-time bounded tasks that across multiple subscriptions of a multi-subscription wireless communication device in order to achieve coordinated subscription activity and minimize power consumption associated with having only one radio resource active at a point in time. Various embodiments may be implemented on a multi-subscription wireless communication device supporting at least a first subscription associated with a first radio resource and a second subscription associated with a second radio resource, and may include determining whether a frequency utilized by the first radio resource interferes with or will interfere with the frequency utilized by the second radio resource, and scheduling tasks of the first subscription and tasks of the second subscription according to a coordination scheduling strategy in response to determining that the frequency utilized by the first radio resource does not interfere with the frequency utilized by the second radio resource.

In some embodiments, scheduling the tasks of the first subscription and the tasks of the second subscription according to the coordination scheduling strategy in response to determining that the frequency utilized by the first radio resource does not interfere with the frequency utilized by the second radio resource may include identifying the tasks of the first subscription and the tasks of the second subscription that are non-time bounded tasks, identifying when the first radio resource will be idle, and identifying when the second radio resources will be idle.

Such embodiments may further include scheduling one or more of the non-time bounded tasks of the first subscription during periods in which the first radio resource is idle and the second radio resource is active. Such embodiments may further include, not rescheduling one or more of the non-time bounded tasks of the first subscription during periods in which the first radio resource is idle and the second radio resource is active, if a third radio resource is or will be active when the one or more tasks of the first subscription will be active. Alternatively, in such embodiments, scheduling the one or more non-time bounded tasks of the first subscription during periods in which the first radio resource is idle and the second radio resource is active may include rescheduling the one or more tasks of the first subscription to a different period than an default period in which the one or more tasks of the first subscription were scheduled.

Alternatively, such embodiments may include scheduling one or more non-time bounded tasks of the second subscription during periods in which the second radio resource is idle and the first radio resource is active.

Alternatively, such embodiments may include scheduling one or more non-time bounded tasks of the first subscription during periods in which the first radio resource is idle and the second radio resource is active, and scheduling one or more non-time bounded tasks of the second subscription during periods in which the second radio resource is idle and the first radio resource is active. Such embodiments may include determining whether the tasks of the first subscription and the tasks of the second subscription are scheduled to execute substantially concurrently, and scheduling excess tasks of the non-time bounded tasks of either the first subscription or the second subscription at a later time in response to determining that the tasks of the first subscription and the tasks of the second subscription are not scheduled to execute substantially concurrently.

Alternatively, such embodiments may further include scheduling tasks of the first subscription and tasks of the second subscription to execute substantially concurrently.

In some embodiments, determining whether the frequency utilized by the first radio resource interferes or will interfere with the frequency utilized by the second radio resource may include accessing a lookup table containing frequency combinations known to result in signal interference.

In some embodiments, executing the tasks of the first subscription and the tasks of the second subscription according to a default scheduling strategy in response to determining that the frequency utilized by the first radio resource interferes with or will interfere with the frequency utilized by the second radio resource.

Various embodiments include a wireless communication device haying a processor configured with processor-executable instructions to perform operations of the methods described above. Various embodiments include a wireless communication device haying means for performing functions of the methods described above. Various embodiments include a non-transitory processor-readable medium on which are stored processor-executable software instructions to cause a processor of a wireless communication device to perform operations of the methods described above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a communication system block diagram of a network suitable for use with various embodiments.

FIG. 2 is a block diagram illustrating a dual-subscription dual active wireless communications device according to various embodiments.

FIG. 3 is a block diagram illustrating example protocol layer stacks in a dual-subscription wireless communication device according to various embodiments.

FIG. 4 is a block diagram of a legacy method of scheduling tasks across multiple subscriptions of a wireless communications device.

FIG. 5 is a block diagram of a method of scheduling non-time bounded tasks across multiple subscriptions of a wireless communications device according to various embodiments.

FIGS. 6 is a process flow diagram of a method for scheduling non-time bounded tasks across multiple subscriptions in accordance with various embodiments.

FIG. 7 is a process flow diagram of a method for scheduling non-time bounded tasks according to various embodiments.

FIG. 8 is a component diagram of an example wireless communication device suitable for use with various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

The term “wireless communications device” is used herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, mobile robot, and similar personal electronic devices that include a programmable processor and memory and circuitry for establishing wireless communication pathways and transmitting/receiving data via wireless communication pathways.

As used herein, the terms “subscriber identification module (SIM),” “SIM,” and “SIM card” are used interchangeably to mean a memory that may be an integrated circuit or embedded into a removable card, which stores an International Mobile Subscriber Identity (IMSI), related key, and/or other information used to identify and/or authenticate a wireless communication device on a network. The term SIM may also be used as shorthand reference to a communication network and supported subscription associated with a particular SIM, since the information stored in a SIM enables the wireless communication device to establish a communication link with a particular network, thus the SIM and the communication network, as well as the services and subscriptions supported by that network, correlate to one another.

As used herein, the terms “multi-subscription wireless communication device,” “multi-subscription wireless communication device,” “MSMA device,” “dual-subscription wireless communication device,” “dual-subscription dual active device,” and “DSDA device” are used interchangeably to describe a wireless communication device that is configured to independently handle multiple communication network subscriptions and is capable of supporting multiple SIMs.

As used herein, the terms “wireless network” and “cellular network” are used interchangeably to describe a wireless network of a carrier associated with a wireless communication device and/or subscription on a wireless communication device, and/or its roaming partners.

In current mobile communications, wireless service carriers have standardized a number of techniques for selecting, obtaining, and maintaining service from wireless communications systems, in accordance with preferences of the subscriber's service provider/carrier. Service providers generally enable subscribers to access a network by providing provisioning information to subscriber devices. Access to communication networks may be maintained by periodic exchange of paging signals. For clarity, the embodiments are described below for GSM-type and/or UMTS-type networks, but may be applied to networks using any other radio technology or protocol.

A multi-subscription wireless communication device, which supports two or more SIM cards, may have a number of capabilities that provide convenience to a user, such as allowing different wireless carriers, plans, telephone numbers, billing accounts, etc. on one device. Developments in multi-subscription wireless communication device technology have led to a variety of different options for such devices. For example, an “active multi-subscription” wireless communication device allows at least two subscriptions to remain active and accessible to the device. In particular, a type of active multi-subscription wireless communication device may be a “dual-subscription dual-active” (DSDA) wireless communication device in which two subscriptions are configured to use separate transceivers (i.e., radio resources). Thus, in a DSDA device the subscriptions may simultaneously operate in any of a variety of modes, such as active/connected mode (i.e., transmitting and/or receiving data), idle mode, etc. Other multi-subscription wireless communication devices may be configured to operate more than two subscriptions in simultaneous active connections, such as by providing a separate transceiver for each of at least three subscriptions.

Although multi-subscription wireless communication devices offer a variety of options to the end user, they also necessitate efficient execution of complex tasks. In multi-subscription resource management, multiple subscriptions may generally be handled separately with respect to out-of-service recovery and power-up scenarios. In particular, DSDA devices generally have separate modem stacks to operate using their respective radio resources.

Various embodiments may include methods and devices that reduce power consumption on a multi-subscription communication device in the execution of non-time bounded network communication activities by two or more subscriptions by scheduling tasks to achieve concurrent use of the radio resources associated with the subscriptions. Subscriptions utilizing non-interfering RATs may have their respective non-time bounded tasks scheduled or rescheduled to consolidate tasks into blocks, which may be executed substantially concurrently across two or more subscriptions. Adjusting the execution of non-time bounded network activities of two or more subscriptions to enable a maximum number of subscriptions to operate at the same time may save power consumption by reducing the amount of time that radio resources are energized.

Each RF resource may interact with a central resource manager module for requesting use of RF resources. The resource manager may analyze or otherwise review the RAT needs of each subscription and may determine whether the frequencies of any two RATs interfere with one another. For example, the resource manager may review the RATs utilized by a requesting subscription in execution of the subscription's tasks, and may compare the frequency of that RAT to the frequencies of RATs utilized by other subscriptions in executing the tasks of those subscriptions. The central resource manager module may then implement an algorithm that identifies non-time bounded activities of each affected subscription so that execution of tasks by two or more subscriptions overlap in time. In addition, non-time bound activities (e.g., neighbor cell measurements) of one subscription may be scheduled to occur at the same time as time bounded activities (e.g., page demodulations) of another subscription.

In an example, a GSM subscription may need to wake up to receive process page bursts (a time bounded activity) and a WCDMA subscription may be scheduled to make periodic neighbor cell measurements (a non-time bounded activity) at a time interval after the first subscription executes the process page bursts. The timing of the page burst monitor events may be known by the central resource manager module, which may determine that the RAT frequencies of both subscriptions do not interfere and may schedule the WCDMA subscription to wake up to perform neighbor cell measurements (and other non-time bounded activities) at approximately the same time as the GSM subscription is receiving and processing page bursts. As a result of doing so, both the GSM and the WCDMA subscriptions may be active at approximately the same time and may return to an idle or dormant state at approximately the same time, thereby shortening the duration that the device is powered and reducing the power consumption cost of executing the tasks.

Various embodiments provide methods that schedule non-time bounded tasks of multiple subscriptions in a wireless communications device by taking into account whether the network activities of two or more of the subscriptions lead to coexistence interference (de-sense). In the event that frequency interference is detected, the central resource manager may resort to implementing a default scheduling strategy (i.e., the legacy approach) to network monitoring scheduling (i.e., independent scheduling+de-sense mitigation).

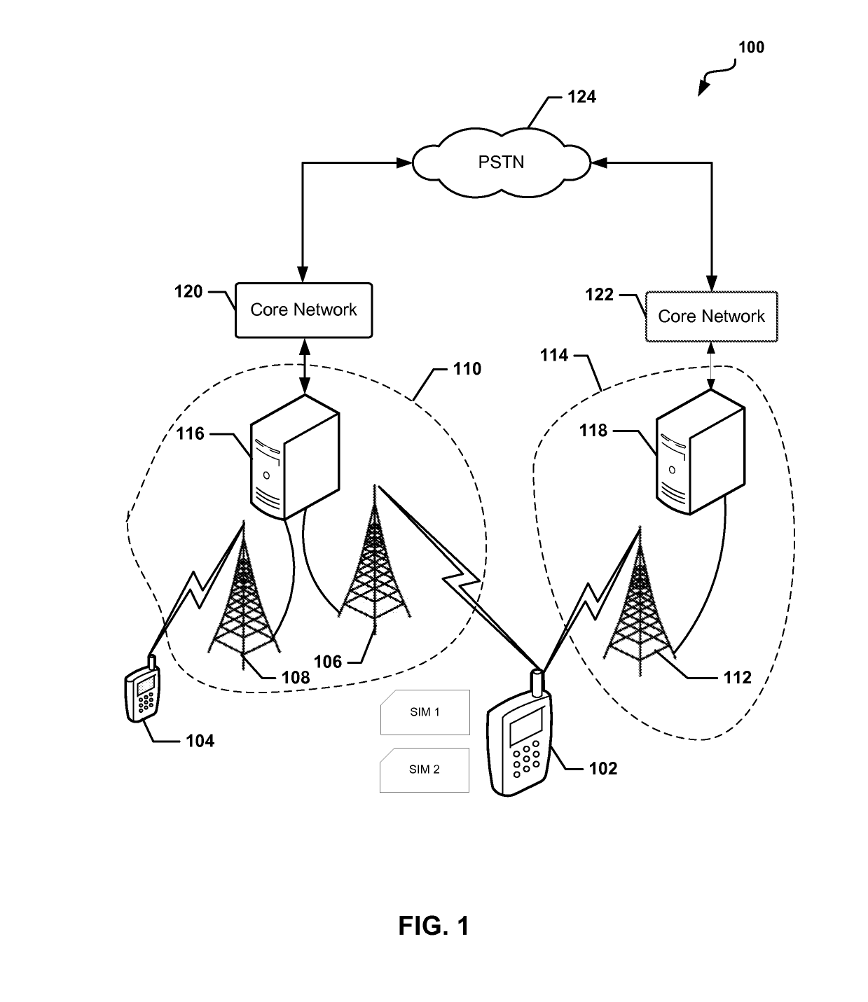

FIG. 1 illustrates a wireless network system 100 suitable for use with various embodiments. Wireless communication devices 102, 104 may be configured to establish wireless connections with cell towers or base stations of one or more radio access networks. For example, the wireless communication devices 102, 104 may transmit/receive data using base stations 106, 108, which may be part of a network 110, as is known in the art. The wireless communication device 102 may further be configured to transmit/receive data through base station 112, which may be part of a different network 114.

The wireless networks 110, 114 may be cellular data networks, and may use channel access methods including, but not limited to, Frequency Division Multiple Access (FDMA), Time Division Multiple Access (TDMA), Code Division Multiple Access (CDMA), Universal Mobile Telecommunications Systems (UMTS) (particularly, Long Term Evolution (LTE)), Global System for Mobile Communications (GSM), Wi-Fi, PCS, or other protocols that may be used in a wireless communications network or a data communications network. The networks 110, 114 may use the same or different wireless interfaces and/or physical layers. In some embodiments, the base stations 106, 108, 112 may be controlled by one or more base station controllers (BSC) 116, 118. For example, the base stations 106, 108, the BSC 116, and other components may form the network 110, as is known in the art. Alternate network configurations may also be used and the embodiments are not limited to the configuration illustrated. For example, in some embodiments the functionality of the BSC 116 and at least one of the base stations 106, 108 may be collapsed into a single “hybrid” module having the functionality of these components.

In various embodiments, the wireless communication device 102 may simultaneously access core networks 120, 122 after camping on cells managed by the base stations 106, 112. The wireless communication device 102 may also establish connections with Wi-Fi access points, which may connect to the Internet. While various embodiments are particularly useful with wireless networks, the embodiments are not limited to wireless networks and may be implemented over wired networks with no changes to the methods.

In the wireless network system 100, the wireless communication device 102 may be a multi-subscription wireless communication device that is capable of operating on a plurality of subscriptions. For example, the wireless communication device 102 may be a dual-subscription wireless communication device. Using dual-subscription functionality, the wireless communication device 102 may simultaneously access two core networks 120, 122 by camping on cells managed by the base stations 106, 112. The core networks 120, 122 may be interconnected by public switched telephone network (PSTN) 124, across which the core networks 120, 122 may route various incoming and outgoing communications to the wireless communication device 102.

The wireless communication device 102 may make a voice or data call to a third party device, such as wireless communication device 104, using one of the subscriptions. The wireless communication device 102 may also receive a voice call or other data transmission from a third party. The third party device (e.g., wireless communication device 104) may be any of a variety of devices, including, but not limited to, a mobile phone, laptop computer, PDA, server, etc.).

Some or all of the wireless communication devices 102 may be configured with multi-mode capabilities and may include multiple transceivers for communicating with different wireless networks over different wireless links/radio access technologies. For example, the wireless communication device 102 may be configured to communicate over multiple wireless data networks on different subscriptions, such as in a dual-subscription wireless communication device. In particular, the wireless communication device 102 may be configured with dual-subscription dual active (DSDA) capability, which enables a dual-subscription wireless communication device to simultaneously participate in two independent communications sessions, generally though independent transmit/receive chains.

For clarity, while the techniques and embodiments described herein relate to a wireless communication device configured with at least one GSM subscription, they may be extended to subscriptions on other radio access networks (e.g., UMTS/WCDMA, LTE, CDMA, etc.).

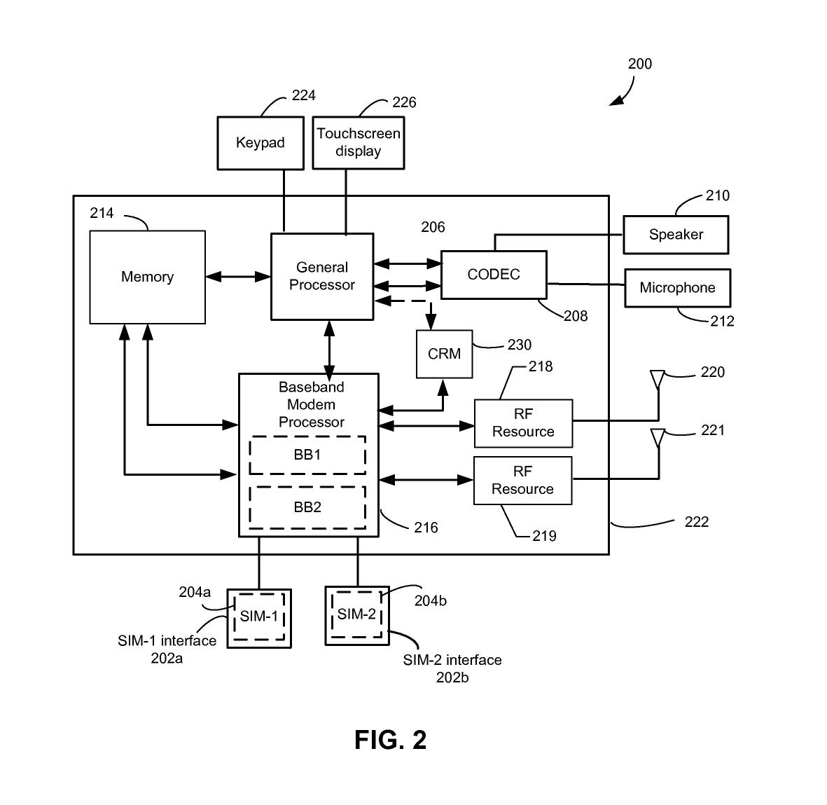

FIG. 2 is a functional block diagram of an example DSDA multi-subscription wireless communication device 200 that is suitable for implementing various embodiments. With reference to FIGS. 1-2, in various embodiments, the wireless communication device 200, which may be similar to the wireless communication devices 102, 104 as described, may include a first SIM interface 202a, which may receive a first identity module SIM 204a that is associated with the first subscription. The wireless communication device 200 may also include a second SIM interface 202b, which may receive a second identity module SIM 204b that is associated with the second subscription.

A SIM in various embodiments may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. One or more of the SIMs 204a, 204b used in various embodiments may contain user account information, an IMSI a set of SIM application toolkit (SAT) commands and storage space for phone book contacts. One or more of the SIMs 204a, 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more of the SIMs 204a, 204b for identification.

The wireless communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. Memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions.

The general purpose processor 206 and memory 214 may each be coupled to at least one baseband modem processor 216. Each subscription in the wireless communication device 200 may be associated with a baseband-RF resource chain that includes a baseband modem processor 216 and a radio resource/RF resource 218, 219. In some embodiments, the wireless communication device may have additional RF resources, such as a third radio resource or more. The RF resources 218, 219 may be coupled to antennas 220, 221, and may perform transmit/receive functions for the wireless services associated with each subscription of the wireless communication device 200. In some embodiments, the RF resources 218, 219 may be coupled to wireless antennas 220, 221 for sending and receiving RF signals for the subscriptions thereby enabling the wireless communication device 200 to perform simultaneous communications with separate networks and/or service associated with the subscriptions. The RF resources 218, 219 may provide separate transmit and receive functionality, or may include a transceiver that combines transmitter and receiver functions. In some embodiments, a central resource manager 230, may be implemented in the general purpose processor 206 or baseband processor 216 in order to enable protocol implementation on the multiple subscriptions of the device. The central resource manager 230 may be a module that facilitates protocol stack functionality.

In some embodiments, the general purpose processor 206, memory 214, baseband modem processor(s) 216, and RF resources 218, 219 may be included in a system-on-chip device 222. The first and second SIMs 204a, 204b and their corresponding interfaces 202a, 202b may be external to the system-on-chip device 222. Further, various input and output devices may be coupled to components of the system-on-chip device 222, such as interfaces or controllers. Example user input components suitable for use in the wireless communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between various software modules and functions in the wireless communication device 200 to enable communication between them, as is known in the art.

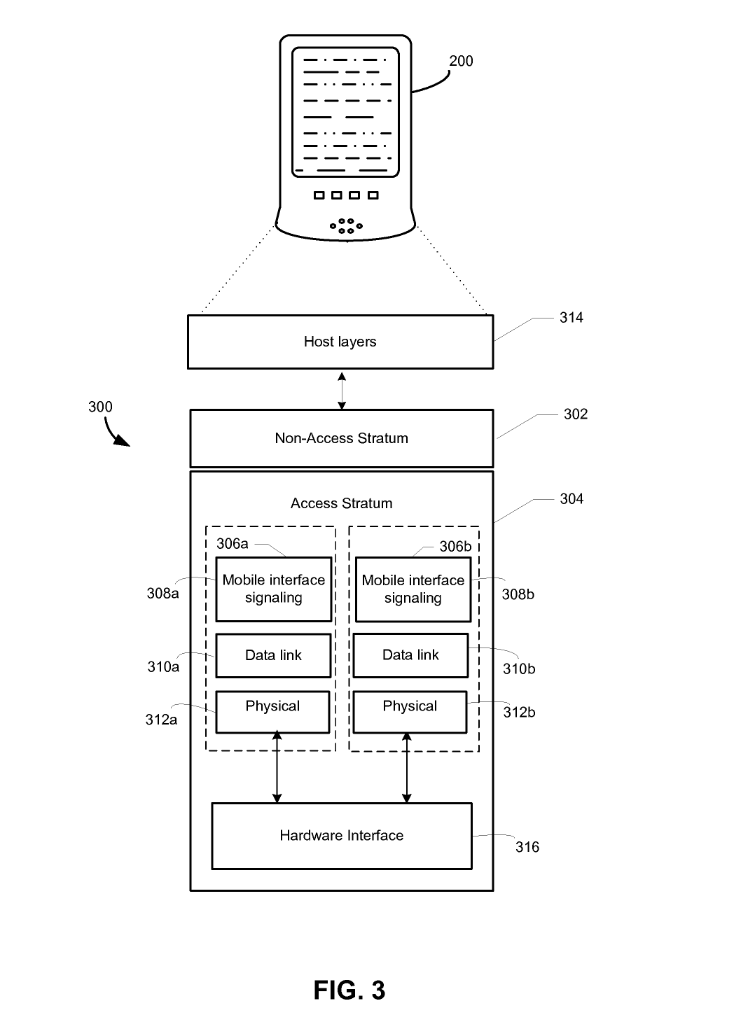

FIG. 3 is a functional block diagram of a layered software architecture 300 in the dual-subscription wireless communication device 200. With reference to FIGS. 1-3, the software architecture 300 may be distributed among one or more processors of the wireless communication device 200, such as baseband modem processor(s) 216. The software architecture 300 may also include a Non Access Stratum (NAS) 302 and an Access Stratum (AS) 304. The NAS 302 may include functions and protocols to support traffic and signaling between subscriptions of the wireless communication device 200 (e.g., those subscriptions associated with SIM-1 204a, SIM-2 204b) and their respective core networks. The AS 304 may include functions and protocols that support communication between the subscriptions, and entities of their respective access networks (such as a mobile switching center (MSC)if in a GSM network).

In the wireless communication device 200, the AS 304 may include multiple protocol stacks, each of which may be associated with a different SIM. The protocol stacks may be implemented to allow modem operation using information provisioned on multiple SIMs. Therefore, a protocol stack that may be executed by a baseband modem processor (e.g., 216) is interchangeably referred to herein as a modem stack.

In some embodiments, the AS 304 may include protocol stacks 306a, 306b, associated with the subscriptions, respectively. Although described below with reference to GSM-type communication layers, the protocol stacks 306a, 306b may support any of variety of standards and protocols for wireless communications. The protocol stacks 306a, 306b may respectively include mobile interface signaling layers 308a, 308b, which may each be implementations of Layer 3 of a GSM signaling protocol (equivalent to radio resource control layer in implementation of UMTS signaling protocol Layer 3). Further, each of the mobile interface signaling layers 308a, 308b may include at least one sublayer (not shown). Sublayers may include, but are not limited to, connection management (CM) sublayers that provide call management for circuit-switched communications, mobility management (MM) sublayers that may support the mobility of user devices (e.g., location update procedures, IMSI attach/detach etc.), and radio resource management (RR) sublayers that may oversee the establishment of links between the wireless communication device 200 and associated access networks, including management of the frequency spectrum, channel assignment and handover, power-level control, and signal measurements. In various embodiments, the NAS 302 and RR sublayers may perform various functions to search for wireless networks.

Residing below the mobile interface signaling layers 308a, 308b, protocol stacks 306a, 306b may also include data link layers 310a, 310b, which may be part of Layer 2 in a GSM signaling protocol. The data link layers 310a, 310b may provide functions to handle incoming and outgoing data across the network, such as dividing output data into data frames and analyzing incoming data to ensure it has been successfully received. In some embodiments, each data link layer 310a, 310b may contain various sub-layers (e.g., media access control (MAC) and logical link control (LLC) layers (not shown)). Residing below the data link layers 310a, 310b, the protocol stacks 306a, 306b may also include physical layers 312a, 312b, which may establish connections over the air interface and manage network resources for the wireless communication device 200.

While the protocol stacks 306a, 306b provide functions to transmit data through physical media, the software architecture 300 may further include at least one host layer 314 to provide data transfer services to various applications in the wireless communication device 200. In some embodiments, application-specific functions provided by the at least one host layer 314 may provide an interface between the protocol stacks 306a, 306b and the general purpose processor 206. In some embodiments, the functions of the host layer 314 and the host layer's interactions with the general purpose processor 206 and baseband processor 216 (i.e., protocol stack functions) may be carried out by the central resource manager 230. The central resource manager 230 may be a module that enables or carries out protocol stack tasks as indicated by the host layer 314. In some embodiments, the protocol stacks 306a, 306b may each include one or more higher-logical layers (e.g., transport, session, presentation, application, etc.) that provide host layer functions. In some embodiments, the software architecture 300 may further include in the AS 304 a hardware interface 316 between the physical layers 312a, 312b and the communication hardware (e.g., one or more RF transceivers).

Separate units of the baseband-modem processor of the multi-subscription wireless communication device may be implemented as separate structures or as separate logical units within the same structure, and may be configured to execute software including at least two protocol/modem stacks associated with at least two subscriptions, respectively. The subscriptions and associated modem stacks may be configured to support a variety of communication services that fulfill different user requirements. Further, a particular subscription may be provisioned with information to execute different signaling procedures for accessing a domain of the core network associated with these services and for handling data thereof

A modem stack may be configured to connect to networks in any of a number of radio access technologies. While described with respect to GSM and/or UMTS networks, these are merely examples of networks that may be searched by radio resources associated with the modem stacks of various embodiments.

In an idle mode, a subscription may implement a power-saving mode that includes a cycle of sleep and awake states (e.g., discontinuous reception (DRX)). A modem stack in such a power-saving mode may monitor paging channels/receive network pages (i.e., radio use) during the awake state, and may power off most processes and components, including the associated radio resource, during the sleep state. Therefore, for a substantial portion of time in the idle mode, an associated radio resource may be unused.

Various embodiments may take advantage of the flexible execution timing of non-time bounded tasks of multiple subscriptions by scheduling or rescheduling the non-time bounded tasks of subscriptions utilizing non-interfering RATs to execute substantially concurrently. For example, prior to or during execution of tasks of any time (i.e. time bounded or non-time bounded) by a first subscription, the central resource manager may determine whether the RAT frequency utilized by the first subscription (e.g., currently in use, or needed for execution of upcoming tasks) interferes with RAT frequencies required by other subscriptions to execute the tasks of those subscriptions. If the frequencies are non-interfering, the non-time bounded tasks of each subscription may have their position within a respective task execution queue adjusted. The execution queue position of non-time bounded tasks may be adjusted up or down within the task execution queue (i.e., forward in queue position or back) in order to consolidate tasks across two or more subscriptions into a condensed block of execution time. Task positions within the task execution queue may be modified until the execution time of the blocks of execution time for each subscription are as close to equal as allowable given the nature and duration of tasks within the execution queue of each subscription.

Once scheduling is completed, all subscriptions may enter an active mode and may commence execution of all tasks within their respective block of execution time. At the culmination of the tasks within the blocks of execution time, all subscriptions may enter an idle or dormant mode for a period in order to reduce power consumption. Thus, the duration of time that only a single subscription is active is reduced and the amount of time during which all subscriptions are idle are dormant is increased. Such conditions may result in power savings and thereby may improve battery life of the wireless communications device.

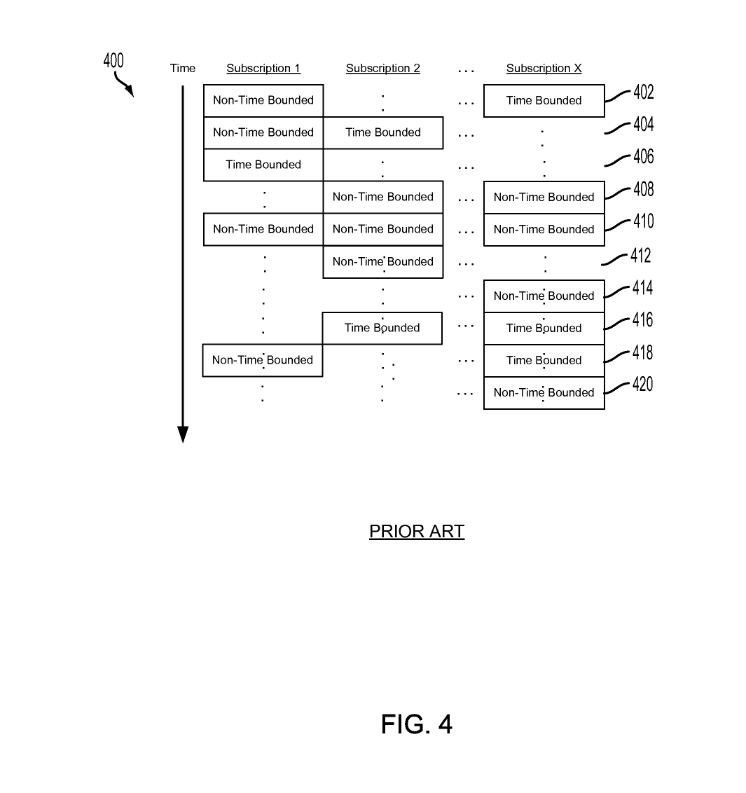

FIG. 4 shows a timeline 400 of communication tasks across multiple subscriptions of a wireless communications device in which no rescheduling of non-time bounded tasks is accomplished as per conventional practice. In a default scheduling strategy or legacy method, tasks may be executed according to a modified first-in first-out (FIFO) queuing scheme. Time bounded tasks (e.g., page reads) may have a temporal significance and therefore are executed at specific times, time intervals, or time offsets. As such, the position of time bounded tasks within the execution queue for each subscription may be set or immutable. Conversely, non-time bounded tasks (e.g., neighbor reads, overhead collection etc.) lack temporal significance and may be inserted into an execution queue as the tasks arise. Thus, in a default scheduling strategy implementation, time bounded tasks may be pre-scheduled or assigned to specific positions within a subscription's execution queue and non-time bounded tasks may be “tacked on” or inserted ad hoc.

For example, a first subscription (i.e., a first radio resource accessing a first subscription) may have a non-time bounded task for execution at a time t=1 402, while a second subscription (i.e., a second radio resource accessing a second subscription) has no tasks scheduled for execution, and a third subscription (i.e., a third radio resource accessing a third subscription) has a time-bounded task ready for execution. Because the third subscription has a time-bounded task the third subscription must be in an active state at the time t=1 402, the first subscription will also be active because the first subscription is executing a non-time bounded task that happens to be at the top of the first subscription execution queue. The second subscription will remain idle or dormant for a period at that time t=1 402 because the second subscription has no tasks scheduled for execution.

At time a t=2 404, the first subscription may remain active to execute another non-time bounded task, the second subscription may “wake up” and enter an active mode to execute a time-bounded task, and the third subscription may enter an idle or dormant mode to await further tasks. At a time t=3 406, the first subscription may have a time bounded task at the top of the first subscription execution queue and may remain active to execute the time bounded task. The second subscription may return to an idle or dormant mode and the third subscription may remain in the idle or dormant mode.

As illustrated in FIG. 4, the execution queues of each subscription are conventionally scheduled independently of each other, resulting in a lack of coordination with respect to instances in which each subscription operates in an active mode. For example, at a time t=4 408 the first subscription enters an idle mode after executing the tasks of times 402, 404, and 406, while the second and third subscriptions wake up and enter an active mode. At a time t=5 410, all subscriptions are active and executing tasks, but at a time t=6 412, the first and third subscriptions are in the idle or dormant mode while the second subscription remains active to execute a non-time bounded task. The various subscriptions may continue to wake up (i.e., enter an active mode) and sleep (i.e., enter an idle or dormant mode) from times 414 to 420.

The lack of coordination in scheduling task execution across the multiple subscriptions may result in prolonged or unnecessary instances of subscriptions communicating, requiring the wireless communication device to be operating in an active mode. In the example illustrated in FIG. 4, the independent scheduling of tasks on a per subscription basis for ten time intervals 402-420 results in ten time periods in which at least one subscription is in an active mode. Time periods during which only a portion of the subscriptions are in an active mode may lead to increased overall power consumption because the total duration of task executions across all subscriptions may be prolonged due to one or more interim idle or dormant periods (i.e., periods in which a subscription remains unused).

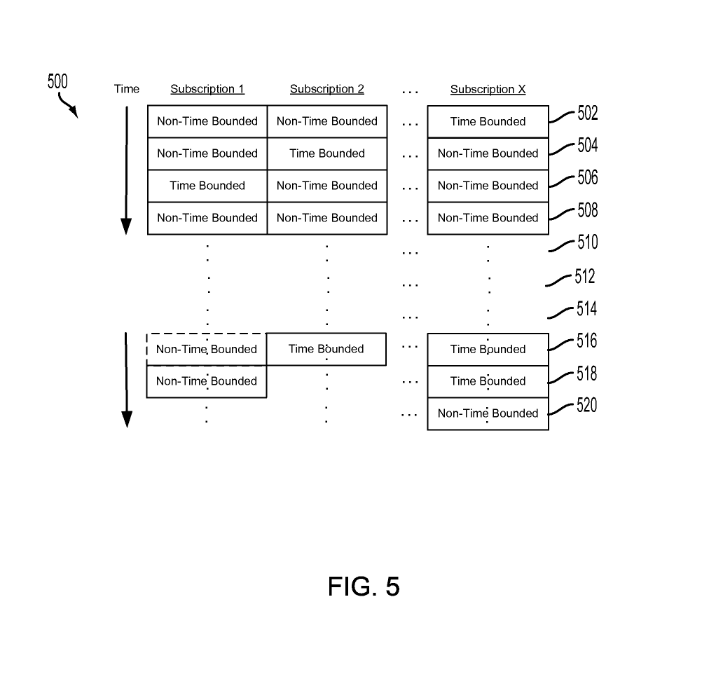

FIG. 5 shows a timeline 500 of tasks across multiple subscriptions of a wireless communications device in which rescheduling of non-time bounded tasks is accomplished according to various embodiments. With reference to FIGS. 1-3 and 5, a processor (e.g., a general purpose processor 206 or a baseband modem processor 216) of a wireless communications device (e.g., 200) may implement algorithms to coordinate execution of tasks across subscriptions associated with non-interfering RAT frequencies. A central resource manager 230 may select two or more non-interfering subscriptions of the multiple-subscription wireless communications device for implementing a coordination strategy for scheduling tasks. Subscriptions that are identified as interfering with one or more active subscriptions may be scheduled according to a legacy or default scheduling method or may have non-time bounded task execution suspended until interfering active subscriptions enter an idle or dormant mode.

As a threshold inquiry, the central resource manager may determine the combinations of subscriptions that may be active simultaneously without significant interference (i.e., de-sense). In various embodiments, this information may be stored in memory (e.g., a lookup table of frequency combinations known to result in interference). The central resource manager may determine the frequencies utilized (or that will be utilized) by the respective RATs of the radio resource associated with each subscription. The determined frequencies may be compared to entries in the lookup table to identify combinations of frequencies that are known to interfere. The lookup table may be pre-populated and/or may be updated as frequency interference is encountered. The determination of whether two RAT frequencies will result in interference may be accomplished through a number of techniques known to those skilled in the art, and as such, the operation of determining frequency interference is not limited to the use of a lookup table or a semi-real time detection implementation.

In some embodiments, the determination of whether the RAT frequency utilized by the radio resource of one subscription interferes with the RAT frequency utilized by another subscription may be determined during execution and may result in rescheduling of tasks to accommodate interfering frequencies. In such embodiments, one of the subscriptions causing the interference may be placed in an idle or dormant mode while the remaining subscription(s) finish execution of their tasks.

The scheduling of task execution across multiple subscriptions to coordinate subscription activity may be implemented on those combinations of subscriptions that the central resource manager identifies as associated with radio resources utilizing non-interfering RAT frequencies. Various embodiments may include the central resource manager identifying the tasks within each subscription execution queue that are time bounded (i.e., must remain in their given queue position) and that are non-time bounded (i.e., those that may be moved in position within the queue). The central resource manager may analyze the execution queues of each non-interfering subscription to identify time periods during which some but not all of the subscriptions are idle or dormant. Once non-time bounded tasks and idle periods for each subscription are identified, the central resource manager may begin scheduling/rescheduling non-time bounded tasks.

Various embodiments may include algorithms for selecting non-time bounded tasks and adjusting their position within respective execution queues to create blocks of execution time in which there is little or no idle time (i.e., time in which the subscription operates in an idle or dormant mode). An example is shown the timeline 500, which includes the same number and subscription distribution of tasks as shown in the timeline 400 (FIG. 4), but illustrates the result of rescheduling the non-time bounded tasks of each subscription to fill earlier time gaps and consolidate tasks according to various embodiments. In the illustrated example, the non-time bounded tasks executed in the timeline 400 at time periods 410, 412, and 414 are adjusted within the execution queues in order to consolidate task execution times into three execution time blocks during which activity is continuous. The first, second, and third subscriptions may all execute tasks substantially concurrently from time periods t=1 502 to t=4 508. At the time t=5 510, all three subscriptions may enter an idle or dormant mode having completed their execution task, thereby reducing power consumption during this time period.

The generation of consolidated blocks of execution time by scheduling non-time bounded tasks during idle periods may not always be possible. If an execution queue has more idle periods than non-time bounded tasks, the central resource manager will not be able to fill all idle periods by moving non-time bounded tasks within the task's respective execution queues. Similarly, if an execution queue has only time-bounded tasks, then no rescheduling may be permissible for those tasks due to the temporal requirements of such tasks.

In the timeline 500, time periods 516, 518, and 520 show a scheduling scenario in which the number and type of tasks within the execution queue of each subscription render it impossible to create three symmetrical blocks of execution time. The first subscription has a single non-time bounded task scheduled to execute at the time t=9 518. The second subscription has a single time-bounded task that must execute at the time t=8 516. The third subscription has a time bounded task scheduled for execution at the time t=8 516, a time bounded task scheduled for execution at the time t=9 518, and a non-time bounded task scheduled for execution at the time t=10 520, thereby effectively creating a continuous block of execution time.

Because all of the third subscription's time slots are scheduled for activity during the time periods 516 to 520, and both the first subscription and second subscription have idle time periods, the central resource manager may attempt to reschedule tasks of the first and second subscription to coincide with those of the third subscription. The task of the second subscription is time bounded and thus is not rescheduled. The task of the first subscription is non-time bounded and thus may be moved within the first subscription's execution queue, such as by optionally moving the first task up from the default period at time t=9 518 to a different period at time t=8 516. Adjusting the position of the non-time bounded task within the execution queue of the first subscription may enable all three subscriptions to operate in active mode at the same time, allowing both the first and second subscription to enter an idle or dormant state at substantially the same time. However, the third subscription may remain active at 518 and 520 regardless of whether the non-time bounded task of the first subscription is moved and the first and second subscription execute their tasks substantially concurrently.

To further reduce the duration of non-overlapping subscription activity, the execution of tasks within each block of execution time may begin substantially concurrently. As shown in the timeline 500, the first set of blocks of execution time, those tasks scheduled for execution during time periods 502-508 may begin to execute at the time t=1 502 and may end substantially concurrently at the time period 508. All subscriptions may enter an idle or dormant mode at substantially the same time, namely the time t=5 510, and may remain in a power savings mode until the time t=8 516. At that time the subscriptions may “wake up” at substantially the same time and begin execution of the next set of tasks in the subscriptions' respective execution queues.

Thus, to maximize the amount of time in which all subscriptions are dormant, the central resource manager may schedule all blocks of execution time (i.e., all groupings of tasks ready for execution) to begin and end substantially concurrently. In the example illustrated in the timeline 500, the first set of blocks of execution time requires four units of time to complete and the second set of blocks of execution time requires three units of time to complete, making the total execution duration seven units of time. Thus, the coordination scheduling strategy achieves three units of time out of the ten time units in which all subscriptions are in a power saving mode, thus enabling the wireless communication device to power down. The legacy scheduling scheme discussed with reference to the timeline 400, required total execution duration of all ten units of observed time and may be considered as less advantageous for power consumption reduction than the various embodiments described herein.

In some embodiments, when it is not possible to execute all tasks of the multiple subscriptions substantially concurrently, excess tasks may be scheduled for later execution. Referring to the timeline 500, this scheduling technique may include scheduling the non-time bounded task of the third subscription, which is scheduled to execute at the time t=10 520, at a later time such as with other activities (e.g., time-bounded activities scheduled for execution during subsequent time periods). This may reduce the number of time periods between 516 and 520 during which only one subscription is active from three periods to two periods.

In some embodiments, if no reduction in the number of time periods in which only a portion of the subscriptions are active can be achieved due to the nature of the tasks in the various execution queues, then a default or legacy scheduling scheme may be utilized. That is to say, that if no modification of task position within each execution queue is advantageously feasible, then the execution queues may be left in the default scheduling times.

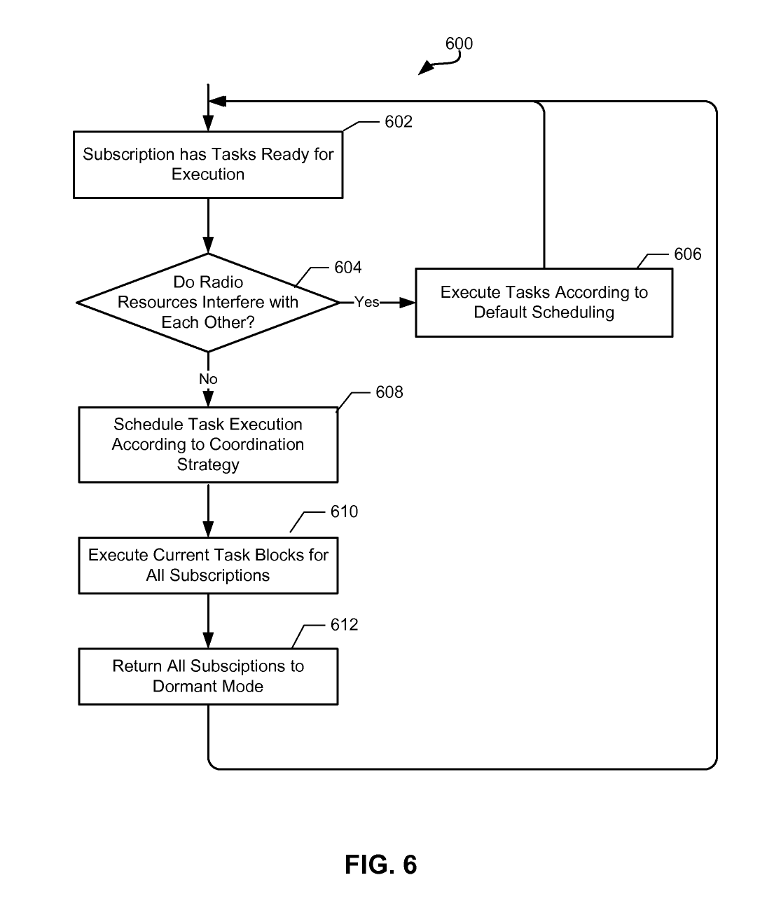

FIG. 6 illustrates a method 600 for improving power consumption in a wireless communications device by scheduling non-time bounded tasks across multiple non-interfering subscriptions according to various embodiments. With reference to FIGS. 1-3, 5, and 6, the operations of the method 600 may be implemented by one or more processors of a wireless communication device 200, such as the general purpose processor 206 and/or baseband modem processor(s) 216, or a separate controller that may be coupled to memory 214 and to the baseband modem processor(s) 216.

In block 602, the wireless communication device processor may receive an indication that one or more subscriptions have tasks ready for execution (i.e., tasks sitting at the top of a respective execution queue). The processor may preemptively check the execution queues of each subscription to identify tasks that will soon be ready for execution, or may wait until a subscription “wakes up” and enters an active mode before reviewing the subscription's execution queue.

In block 604, the processor may determine whether the frequency of a RAT utilized by a radio resource associated with the subscription interferes with or will interfere with any frequency of a RAT utilized by radio resources associated with other subscriptions. In some embodiments, the processor may access a lookup table, list, or other data structure containing known combinations of interfering frequencies to make this determination. In some embodiments, determining whether frequency combinations results in interference may be accomplished by comparing the respective frequencies.

In response to determining that the frequency of the RAT utilized by the radio resource of the subscription does interfere with one or more frequencies of RATs utilized by radio resources of other subscriptions (i.e., determination block 604=“Yes”), the processor may select any of the interfering subscriptions for scheduling according to a default scheduling scheme, in block 606. In some embodiments, the processor may alternatively include scheduling tasks of an interfering subscription for a time after the current subscription will be done executing its tasks. As discussed, in some circumstance it may not be practical to reschedule tasks if the interfering subscription has time bounded tasks scheduled during the intended time of execution for the current subscription's tasks, in which case default scheduling may take over.

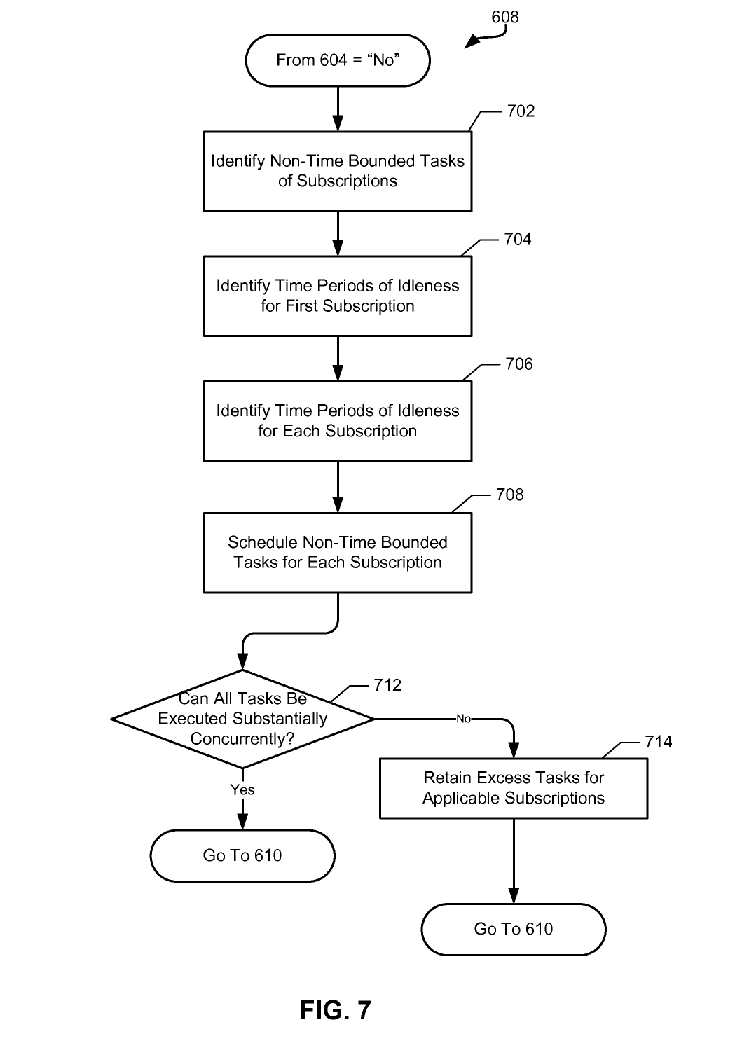

In response to determining that the frequency of the RAT utilized by the radio resource of the subscription does not interfere with one or more frequencies of RATs utilized by radio resources of other subscriptions (i.e., determination block 604=“No”), the processor may schedule tasks of one or more of the subscriptions according to a coordination strategy, in block 608. Example operations for implementing a coordination strategy for block 608 are described (e.g., with reference to FIG. 7).

In block 610, the processor may execute the scheduled task blocks (i.e., blocks of execution time) for each pertinent subscription. The processor may execute both time bounded and non-time bounded tasks within any given execution period. In various embodiments, the processor may include beginning execution of the first task block (i.e., block of execution time) of the execution queue of each subscription at substantially the same time. Similarly, subscriptions subjected to the coordination strategy may end at substantially the same time and may return all pertinent subscriptions to an idle or dormant state, in block 612. The processor may then return to an observational state and await the next instance of a subscription task ready for execution. For example, the processor may check the execution queues of the multiple subscriptions, at regular intervals, during each duty cycle, or as needed.

In other words, various embodiments may provide a method of scheduling non-time bounded tasks across multiple subscriptions of a multi-subscription wireless communication device supporting at least a first subscription associated with a first radio resource and a second subscription associated with a second radio resource. A processor of the wireless communication device may determine whether a frequency utilized by the first radio resource interferes with or will interfere with the frequency utilized by the second radio resource. The processor of the wireless communication device may also schedule tasks of the first subscription and tasks of the second subscription according to a coordination scheduling strategy in response to determining that the frequency utilized by the first radio resource does not interfere with the frequency utilized by the second radio resource.

FIG. 7 illustrates a method 608 for a coordination strategy for scheduling the tasks of multiple subscriptions according to various embodiments. With reference to FIGS. 1-3 and 5-7, the operations of the method 608 may be implemented by one or more processors of the wireless communication device 200, such as the general purpose processor 206 and/or baseband modem processor(s) 216, or a separate controller that may be coupled to memory 214 and to the baseband modem processor(s) 216.

In block 702, the processor of the wireless communication device may identify non-time bounded tasks for each non-interfering subscription. This may include identifying one or more of tasks of the first subscription and one or more of tasks of the second subscription in which the identified tasks are non-time bounded tasks. The processor may review the execution queue of each subscription to determine the nature of the tasks organized therein. As described, time bounded tasks may be scheduled for specific times, time offsets, or time intervals, and thus cannot be rescheduled. Conversely, non-time bounded tasks may be rescheduled by the central resource manager. By first identifying the number of non-time bounded tasks in each execution queue, the processor determines how many tasks can be moved around within each execution queue.

In block 704, the processor may identify periods when the subscription is idle or dormant for the first subscription, which are referred to herein as open time slots. Identifying periods when the subscription is in idle mode may include reviewing the execution queue of each subscription for periods when there is no execution activity scheduled. Open time slots within the execution queue may be reallocated for non-time bounded task execution. The processor may first identify the number of open time slots in the first execution queue (i.e., that associated with the first subscription).

In block 706, the processor may identify open time slots within each of the remaining non-interfering subscriptions. The identification of open time slots within the first subscription may enable the processor to determine how tightly the tasks of the first subscription may be consolidated. Reviewing the open time slots of remaining execution queues may enable the processor to modify the preliminary scheduling plan for the first subscription in order to reduce the amount of time where subscription activities do not overlap (e.g., not all subscriptions are in active mode substantially concurrently).

In block 708, the processor may select the task scheduling arrangement that minimizes the duration of time in which only one radio resource is awake (e.g., non-overlapping periods of activity amongst subscriptions). The processor may schedule or reschedule non-time bounded tasks within each applicable execution queue according to the selected schedule. Thus, tasks may be consolidated into blocks of execution time within an execution queue in which tasks are continuously or substantially continuously scheduled from a start time to an end time. The execution queue of each subscription may have at least one block of execution time, and may optionally have multiple blocks depending on the presence of excess tasks. Various embodiments may include scheduling the first task block (i.e., block of execution time) for the execution queue of each subscription to begin execution at substantially the same time, thereby reducing the duration of time that less than all of the subscriptions are active or dormant.

In determination block 712, the processor may determine whether the schedule for executing the task blocks (i.e., blocks of execution duration) enables substantially concurrent execution of the task blocks of each subscription. In response to determining that the task blocks (i.e., blocks of execution duration) may be executed substantially concurrently across all non-interfering subscriptions (i.e., determination block 712=“Yes”), the processor may begin execution of the task blocks, in block 610 of the method 600 as described.

In response to determining that the task blocks (i.e., blocks of execution duration) cannot be executed substantially concurrently across all non-interfering subscriptions (i.e., determination block 712=“No”), the processor may schedule excess tasks for later execution, in block 714. Excess tasks may be those non-time bounded tasks remaining within an execution queue after task blocks have been generated (e.g., those tasks that if executed would require one subscription to stay active longer than the remaining subscriptions). Excess tasks may be scheduled into blocks of execution duration for future time intervals, thereby reducing scheduling workload in the future. The processor may begin to execute current task blocks across all subscriptions, in block 610 of the method 600 as described.

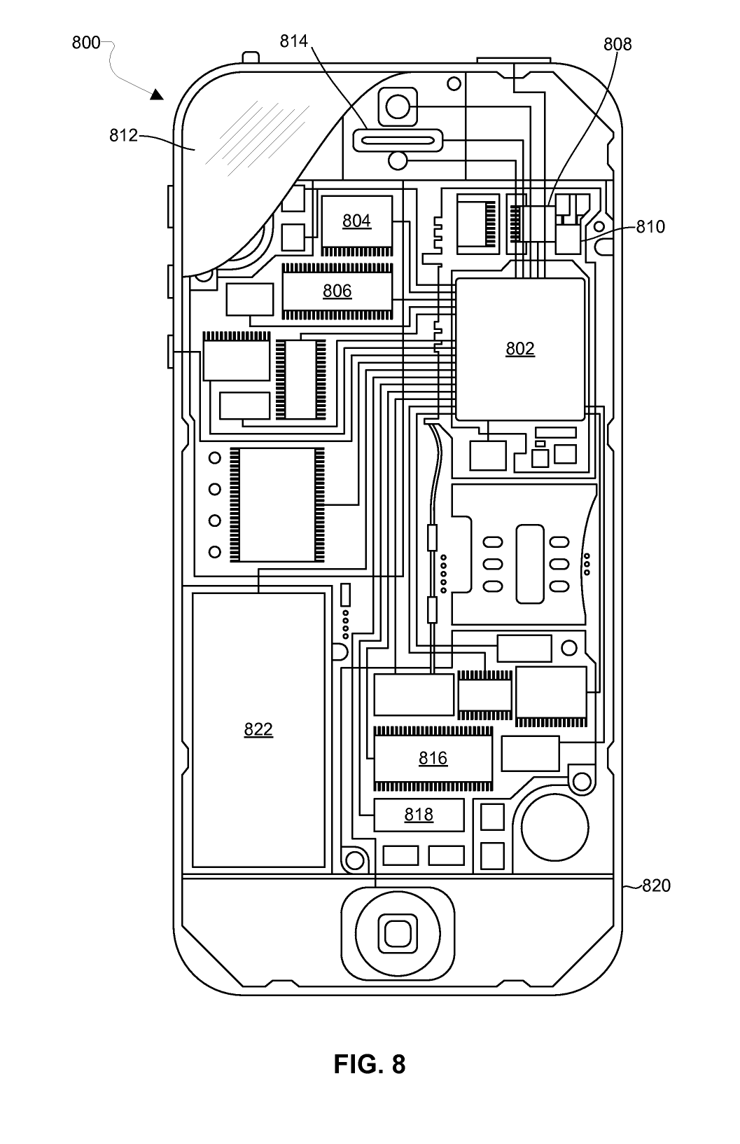

Various embodiments (including the embodiments illustrated in FIGS. 6 and 7) may be implemented in any of a variety of wireless communication devices, an example 800 of which is illustrated in FIG. 8. For example, with reference to FIGS. 1-3 and 5-8, the wireless communication device 800 (which may correspond, for example, the wireless communication device 200 in FIG. 2) may include a processor 802 coupled to a touchscreen controller 804 and an internal memory 806. The processor 802 may be one or more multicore ICs designated for general or specific processing tasks. The internal memory 806 may be volatile or non-volatile memory, and may also be secure and/or encrypted memory, or unsecure and/or unencrypted memory, or any combination thereof

The touchscreen controller 804 and the processor 802 may also be coupled to a touchscreen panel 812, such as a resistive-sensing touchscreen, capacitive-sensing touchscreen, infrared sensing touchscreen, etc. The wireless communication device 800 may have one or more radio signal transceivers 808 (e.g., Peanut®, Bluetooth®, Zigbee®, Wi-Fi, RF radio) and antennae 810, for sending and receiving, coupled to each other and/or to the processor 802. The transceivers 808 and antennae 810 may be used with the above-mentioned circuitry to implement various wireless transmission protocol stacks and interfaces. The multicore device 800 may include a cellular network wireless modem chip 816 that enables communications via a cellular network and is coupled to the processor. The multicore device 800 may include a peripheral device connection interface 818 coupled to the processor 802. The peripheral device connection interface 818 may be singularly configured to accept one type of connection, or multiply configured to accept various types of physical and communication connections, common or proprietary, such as USB, FireWire, Thunderbolt, or PCIe. The peripheral device connection interface 818 may also be coupled to a similarly configured peripheral device connection port (not shown). The multicore device 800 may also include speakers 814 for providing audio outputs. The multicore device 800 may also include a housing 820, constructed of a plastic, metal, or a combination of materials, for containing all or some of the components discussed herein. The multicore device 800 may include a power source 822 coupled to the processor 802, such as a disposable or rechargeable battery. The rechargeable battery may also be coupled to the peripheral device connection port to receive a charging current from a source external to the multicore device 800.

The processor 502 may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory 806 before they are accessed and loaded into the processors 802. The processors 802 may include internal memory sufficient to store the application software instructions. In many wireless communication devices the internal memory may be a volatile or nonvolatile memory, such as flash memory, or a mixture of both. For the purposes of this description, a general reference to memory refers to memory accessible by the processors 802 including internal memory or removable memory plugged into the device and memory within the processor 802, themselves.

The foregoing method descriptions and the process flow diagrams are provided merely as illustrative examples and are not intended to require or imply that the operations of various embodiments must be performed in the order presented. As will be appreciated by one of skill in the art the order of steps in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a subscription and data receiving associated with a different subscription, such identifiers are merely for convenience and are not meant to limit various embodiments to a particular order, sequence, type of network or carrier.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable medium or non-transitory processor-readable medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of scheduling non-time bounded tasks across multiple subscriptions of a multi-subscription wireless communication device supporting at least a first subscription associated with a first radio resource and a second subscription associated with a second radio resource, comprising:
determining whether a frequency utilized by the first radio resource interferes with or will interfere with the frequency utilized by the second radio resource; and
in response to determining that the frequency utilized by the first radio resource does not interfere with the frequency utilized by the second radio resource:
identifying the tasks of the first subscription and the tasks of the second subscription that are non-time bounded tasks; and
scheduling tasks of the first subscription and tasks of the second subscription according to a coordination scheduling strategy.

2. The method of claim 1, wherein in response to determining that the frequency utilized by the first radio resource does not interfere with the frequency utilized by the second radio resource the method further comprises:
identifying when the first radio resource will be idle; and
identifying when the second radio resource will be idle.

3. The method of claim 2, wherein scheduling the tasks of the first subscription and the tasks of the second subscription according to the coordination scheduling strategy in response to determining that the frequency utilized by the first radio resource does not interfere with the frequency utilized by the second radio resource further comprises:
scheduling one or more of the non-time bounded tasks of the first subscription during periods in which the first radio resource is idle and the second radio resource is active.

4. The method of claim 3, further comprising:
not rescheduling one or more of the non-time bounded tasks of the first subscription during periods in which the first radio resource is idle and the second radio resource is active, if a third radio resource is or will be active when the one or more non-time bounded tasks of the first subscription will be active.

5. The method of claim 3, wherein scheduling the one or more non-time bounded tasks of the first subscription during periods in which the first radio resource is idle and the second radio resource is active comprises:
rescheduling the one or more non-time bounded tasks of the first subscription to a different period than an default period in which the one or more non-time bounded tasks of the first subscription were scheduled.

6. The method of claim 2, wherein scheduling the tasks of the first subscription and the tasks of the second subscription according to the coordination scheduling strategy in response to determining that the frequency utilized by the first radio resource does not interfere with the frequency utilized by the second radio resource further comprises:
scheduling one or more non-time bounded tasks of the second subscription during periods in which the second radio resource is idle and the first radio resource is active.

7. The method of claim 2, wherein scheduling the tasks of the first subscription and the tasks of the second subscription according to the coordination scheduling strategy in response to determining that the frequency utilized by the first radio resource does not interfere with the frequency utilized by the second radio resource further comprises:
scheduling one or more non-time bounded tasks of the first subscription during periods in which the first radio resource is idle and the second radio resource is active; and
scheduling one or more non-time bounded tasks of the second subscription during periods in which the second radio resource is idle and the first radio resource is active.

8. The method of claim 7, further comprising:
determining whether the tasks of the first subscription and the tasks of the second subscription are scheduled to execute concurrently; and
scheduling excess tasks of the non-time bounded tasks of either the first subscription or the second subscription at a later time in response to determining that the tasks of the first subscription and the tasks of the second subscription are not scheduled to execute concurrently.

9. The method of claim 2, wherein scheduling the tasks of the first subscription and the tasks of the second subscription according to the coordination scheduling strategy in response to determining that the frequency utilized by the first radio resource does not interfere with the frequency utilized by the second radio resource further comprises scheduling tasks of the first subscription and tasks of the second subscription to execute concurrently.

10. The method of claim 1, wherein determining whether the frequency utilized by the first radio resource interferes or will interfere with the frequency utilized by the second radio resource comprises:
accessing a lookup table containing frequency combinations known to result in signal interference.

11. The method of claim 1, further comprising:
executing the tasks of the first subscription and the tasks of the second subscription according to a default scheduling strategy in response to determining that the frequency utilized by the first radio resource interferes with or will interfere with the frequency utilized by the second radio resource.

12. A multi-subscription wireless communication device, comprising:
a memory;
a first radio resource supporting a first subscription;
a second radio resource supporting a second subscription; and
a processor coupled to the memory, the first radio resource, and the second radio resource, and configured with processor-executable instructions to
determine whether a frequency utilized by the first radio resource interferes with or will interfere with the frequency utilized by the second radio resource; and
in response to determining that the frequency utilized by the first radio resource does not interfere with the frequency utilized by the second radio resource:
identifying the tasks of the first subscription and the tasks of the second subscription that are non-time bounded tasks; and
schedule tasks of the first subscription and tasks of the second subscription according to a coordination scheduling strategy.

13. The multi-subscription wireless communication device of claim 12, wherein the processor is further configured with processor-executable instructions to:
in response to determining that the frequency utilized by the first radio resource does not interfere with the frequency utilized by the second radio resource:
identifying when the first radio resource will be idle; and
identifying when the second radio resource will be idle.

14. The multi-subscription wireless communication device of claim 13, wherein the processor is further configured with processor-executable instructions to schedule the tasks of the first subscription and the tasks of the second subscription according to the coordination scheduling strategy in response to determining that the frequency utilized by the first radio resource does not interfere with the frequency utilized by the second radio resource by:
scheduling one or more of the non-time bounded tasks of the first subscription during periods in which the first radio resource is idle and the second radio resource is active.

15. The multi-subscription wireless communication device of claim 14, wherein the processor is further configured with processor-executable instructions to not reschedule one or more of the non-time bounded tasks of the first subscription during periods in which the first radio resource is idle and the second radio resource is active, if a third radio resource is or will be active when the one or more non-time bounded tasks of the first subscription will be active.

16. The multi-subscription wireless communication device of claim 14, wherein the processor is further configured with processor-executable instructions to: schedule the one or more non-time bounded tasks of the first subscription during periods in which the first radio resource is idle and the second radio resource is active by:
rescheduling the one or more non-time bounded tasks of the first subscription to a different period than a default period in which the one or more non-time bounded tasks of the first subscription were scheduled.

17. The multi-subscription wireless communication device of claim 13, wherein the processor is further configured with processor-executable instructions to schedule the tasks of the first subscription and the tasks of the second subscription according to the coordination scheduling strategy in response to determining that the frequency utilized by the first radio resource does not interfere with the frequency utilized by the second radio resource by:
scheduling one or more non-time bounded tasks of the second subscription during periods in which the second radio resource is idle and the first radio resource is active.

18. The multi-subscription wireless communication device of claim 13, wherein the processor is further configured with processor-executable instructions to schedule the tasks of the first subscription and the tasks of the second subscription according to the coordination scheduling strategy in response to determining that the frequency utilized by the first radio resource does not interfere with the frequency utilized by the second radio resource by:
scheduling one or more non-time bounded tasks of the first subscription during periods in which the first radio resource is idle and the second radio resource is active; and
scheduling one or more non-time bounded tasks of the second subscription during periods in which the second radio resource is idle and the first radio resource is active.

19. The multi-subscription wireless communication device of claim 18, wherein the processor is further configured with processor-executable instructions to:
determine whether the tasks of the first subscription and the tasks of the second subscription are scheduled to execute concurrently; and
schedule excess tasks of the non-time bounded tasks of either the first subscription or the second subscription at a later time in response to determining that the tasks of the first subscription and the tasks of the second subscription are not scheduled to execute concurrently.

20. The multi-subscription wireless communication device of claim 13, wherein the processor is further configured with processor-executable instructions to schedule the tasks of the first subscription and the tasks of the second subscription according to the coordination scheduling strategy in response to determining that the frequency utilized by the first radio resource does not interfere with the frequency utilized by the second radio resource by:
scheduling tasks of the first subscription and tasks of the second subscription to execute substantially concurrently.

21. The multi-subscription wireless communication device of claim 12, wherein the processor is further configured with processor-executable instructions to: determine whether the frequency utilized by the first radio resource interferes or will interfere with the frequency utilized by the second radio resource by:
accessing a lookup table containing frequency combinations known to result in signal interference.

22. The multi-subscription wireless communication device of claim 12, wherein the processor is further configured with processor-executable instructions to:
executing the tasks of the first subscription and the tasks of the second subscription according to a default scheduling strategy in response to determining that the frequency utilized by the first radio resource interferes with or will interfere with the frequency utilized by the second radio resource.

23. A multi-subscription wireless communication device, comprising:
a first radio resource;
a second radio resource;
means for determining whether a frequency utilized by the first radio resource interferes with or will interfere with the frequency utilized by the second radio resource;
means for identifying the tasks of the first subscription and the tasks of the second subscription that are non-time bounded tasks in response to determining that the frequency utilized by the first radio resource does not interfere with the frequency utilized by the second radio resource; and
means for scheduling tasks of a first subscription and tasks of a second subscription according to a coordination scheduling strategy in response to determining that the frequency utilized by the first radio resource does not interfere with the frequency utilized by the second radio resource.

24. A non-transitory processor-readable medium having stored thereon processor-executable instructions configured to cause a processor of a multi-subscription wireless communication device to perform operations comprising:
determining whether a frequency utilized by a first radio resource interferes with or will interfere with the frequency utilized by a second radio resource; and
in response to determining that the frequency utilized by the first radio resource does not interfere with the frequency utilized by the second radio resource:
identifying the tasks of the first subscription and the tasks of the second subscription that are non-time bounded tasks; and
scheduling tasks of a first subscription and tasks of a second subscription according to a coordination scheduling strategy.

25. The non-transitory processor-readable medium of claim 24, wherein in the stored processor-executable instructions are configured to cause the processor of the multi-subscription wireless communication device to perform operations further comprising in response to determining that the frequency utilized by the first radio resource does not interfere with the frequency utilized by the second radio resource:
identifying when the first radio resource will be idle; and
identifying when the second radio resource will be idle.

26. The non-transitory processor-readable medium of claim 25, wherein in the stored processor-executable instructions are configured to cause the processor of the multi-subscription wireless communication device to perform operations such that scheduling the tasks of the first subscription and the tasks of the second subscription according to the coordination scheduling strategy in response to determining that the frequency utilized by the first radio resource does not interfere with the frequency utilized by the second radio resource further comprises:
scheduling one or more of the non-time bounded tasks of the first subscription during periods in which the first radio resource is idle and the second radio resource is active.

27. The non-transitory processor-readable medium of claim 26, wherein in the stored processor-executable instructions are configured to cause the processor of the multi-subscription wireless communication device to perform operations further comprising:
not rescheduling one or more of the non-time bounded tasks of the first subscription during periods in which the first radio resource is idle and the second radio resource is active, if a third radio resource is or will be active when the one or more non-time bounded tasks of the first subscription will be active.

28. The non-transitory processor-readable medium of claim 25, wherein in the stored processor-executable instructions are configured to cause the processor of the multi-subscription wireless communication device to perform operations such that schedule the tasks of the first subscription and the tasks of the second subscription according to the coordination scheduling strategy in response to determining that the frequency utilized by the first radio resource does not interfere with the frequency utilized by the second radio resource further comprises:
scheduling one or more non-time bounded tasks of the first subscription during periods in which the first radio resource is idle and the second radio resource is active; and
scheduling one or more non-time bounded tasks of the second subscription during periods in which the second radio resource is idle and the first radio resource is active.

29. The non-transitory processor-readable medium of claim 28, wherein in the stored processor-executable instructions are configured to cause the processor of the multi-subscription wireless communication device to perform operations further comprising:
determining whether the tasks of the first subscription and the tasks of the second subscription are scheduled to execute concurrently; and
scheduling excess tasks of the non-time bounded tasks of either the first subscription or the second subscription at a later time in response to determining that the tasks of the first subscription and the tasks of the second subscription are not scheduled to execute concurrently.

30. The non-transitory processor-readable medium of claim 24, wherein in the stored processor-executable instructions are configured to cause the processor of the multi-subscription wireless communication device to perform operations further comprising
executing the tasks of the first subscription and the tasks of the second subscription according to a default scheduling strategy in response to determining that the frequency utilized by the first radio resource interferes with or will interfere with the frequency utilized by the second radio resource.
